(19) United States
(12) Patent Application Publication
(10) Pub. No.: US 2006/0103489 A1
(43) Pub. Date: May 18, 2006

(54) Parallel plate waveguide structure

(76) Inventors: Martin Johansson, Molndal (SE); Bengt Svensson, Molndal (SE); Emil Wikgren, Goteborg (DE)

Correspondence Address: NIXON & VANDERHYE, PC, 901 NORTH GLEBE ROAD, 11TH FLOOR, ARLINGTON, VA, 22203, US

(21) Appl. No.: 10/524,240

(22) PCT Filed: Aug. 16, 2002
(86) PCT No.: PCT/SE02/01468

§ 371 Date: Aug. 22, 2005

(51) Int. Cl. H01P 1/18; H01P 1/16

(52) U.S. Cl. 333/157; 333/33; 333/21 R

(57) ABSTRACT

A method and a system for transforming between one or more point type sources and a line source in a transmission line structure. A transmission line path controller is inserted between a first parallel-plate waveguide section and a second parallel-plate waveguide section. The transmission line path controller comprises a curved side to which one end of each waveguide is coupled. The transmission line path controller further comprises a waveguide slot, one side of which is a part of the curved side, coupling the waveguide ends that are coupled to the transmission line path controller. The ends of the waveguides that are not coupled to the transmission line path controller forms the point type source and the line source, respectively.

### TECHNICAL FIELD

The invention concerns parallel-plate waveguide structures and is more particularly directed to transforming between one or more point type sources and a line source in a transmission line structure.

### BACKGROUND

Wireless systems for different applications often use sector, node, antennas to cover a desired azimuth sector angle. The requirements of such an antenna is usually to cover the specified azimuth angle, for example a fairly broad beam of e.g. 30°, 60° or 90°, and to attain a narrow elevation radiation pattern, for example a 5° beamwidth, at the same time.

Some node antennas are linear array antennas with baffles to form the azimuth radiation pattern. This gives a very compact antenna solution. The array is fed by a feed network usually with non-isolated power dividers. This means that the ports of the feed network, as seen from the antenna elements, are not matched. If a portion of the signal is reflected at the aperture, then the power dividers will cause a second reflection to thereby create a standing wave. When an elevation pattern is shaped, it is very important to control the excitation correctly. Reflections between the aperture and the feed network will make this difficult. Additionally the physical limitations on the number of antenna elements in the array will further limit the possibility of shaping the elevation pattern.

To overcome some of these problems a continuous line source could be used instead of an array. A common implementation for node antennas is to use a parallel plate horn, either with a direct flared section or with a reflector, a Hog-horn. This type of antenna can be used to form the elevation pattern, the reflector is particularly useful to be able to shape the radiation pattern. The radiating apertures from these horns are formed as vertical line sources. The azimuth beam is formed by means of a pair of baffles extending from the horn line source aperture. These types of antennas will result in a very flat feed section, the horn section, and a baffle section, the size of which is determined by the azimuth pattern requirement. However, the total length of the antenna will be considerable. These types of antennas are therefore difficult to integrate together with other equipment and would result in an unwieldy structure.

### SUMMARY

An object of the invention is to define a transmission line structure that enables the construction of a compact antenna structure.

A further object of the invention is to define a method and a system for transforming between one or more point type sources and a line source in a transmission line structure.

A still further object of the invention is to define a compact antenna structure.

The aforementioned objects are achieved according to the invention by a method and a system for transforming between one or more point type sources and a line source in a transmission line structure. A transmission line path controller is inserted between a first parallel-plate waveguide section and a second parallel-plate waveguide section. The transmission line path controller comprises a curved side to which one end of each waveguide is coupled. The transmission line path controller further comprises a waveguide slot, one side of which is a part of the curved side, coupling the waveguide ends that are coupled to the transmission line path controller. The ends of the waveguides that are not coupled to the transmission line path controller forms the point type source and the line source, respectively.

The aforementioned objects are also achieved according to the invention by a method of transforming between one or more point type sources and a line source in a transmission line structure. The method comprises inserting a transmission line path controller between a first parallel-plate waveguide section and a second parallel-plate waveguide section. The transmission line path controller comprises a curved side to which one end of each waveguide is coupled. The one or more point sources are arranged on an end of the first waveguide which is not coupled to the transmission path controller and the line source is arranged on an end of the second waveguide which is not coupled to the transmission path controller. The transmission line path controller further comprises a waveguide slot, one side of which is a part of the curved side. The waveguide slot further couples the waveguide ends that are coupled to the transmission line path controller. The method further comprises adjusting the curved side to get a desired path length between each different wave path of the one or more point sources and the corresponding location of the line source.

The aforementioned objects are also achieved according to the invention by a method of transforming between one or more point type sources and a line source in a transmission line structure. The method comprises inserting a first part of a transmission line path controller between a first parallel-plate waveguide section and a second parallel-plate waveguide section and inserting a second part of the transmission line path controller between the second parallel-plate waveguide section and a third parallel-plate waveguide section. The one or more point type sources being arranged at a first end of the first waveguide and the line source being arranged at a first end of the third waveguide. The first part of the transmission line path controller comprises a first curved side to which a second end of the first waveguide and a first end of the second waveguide is coupled. The second part of the transmission line path controller comprises a second curved side to which a second end of the second waveguide and a second end of the third waveguide is coupled. The first part of the transmission line path controller further comprises a first waveguide slot, one side of which is a part of the first curved side. The first waveguide slot further couples the waveguide ends that are coupled to the first part of the transmission line path controller. The second part of the transmission line path controller further comprises a second waveguide slot, one side of which is a part of the second curved side. The second waveguide slot further couples the waveguide ends that are coupled to the second part of the transmission line path controller. The method further comprises adjusting the curved sides to get a desired path length between each different wave path of the one or more point sources and the corresponding location of the line source.

The aforementioned objects are further achieved according to the invention by a transmission line structure. The structure comprises a first parallel-plate waveguide section and at least one first electromagnetic wave port of substantially point character at a first end of the first waveguide. The first waveguide will propagate an electromagnetic wave entered at the at least one first port of the first end of the first waveguide towards a second end of the first waveguide in a first principal propagation direction. A principal direction of a wave is the vector sum of all individual propagation directions along the wavefront of the wave. The structure further comprises a second parallel plate waveguide section and a second electromagnetic wave port of a predetermined line character at a first end of the second waveguide. The second waveguide will propagate in a second principal direction between a second end of the second waveguide and the second port of the first end of the second waveguide an electromagnetic wave which is entered at the at least one first port. According to the invention the structure comprises a transmission line path controller which controls a propagation path length of an electromagnetic wave passing through it in relation to where the electromagnetic wave passes through the path controller. A first part of the path controller further changes the first principal propagation direction to a controller principal propagation direction for an electromagnetic wave entering the at least one first port. The first part of the path controller is coupled to the second end of the first waveguide and comprises a first slot in a first slot plane, the first slot having at least two curved sides.

The transmission line structure can be arranged so that the first slot plane is parallel to the plates of the first waveguide, or that the first slot plane is symmetrically oriented in between the first principal propagation direction and the controller principal propagation direction. The first principal propagation direction and the controller principal propagation direction can suitably be parallel, or form an angle between 0° and 180°.

Suitably a side of the first slot furthest away from the at least one first port, is curved in the first slot plane, and forms a first curved side of the first part of the path controller. Then suitably the at least one other curved side of the first slot is a side opposite the first curved side and is curved in a similar manner, the first slot thus forms a substantially uniformly formed waveguide slot. Suitably the first curved side of the first part of the path controller extends into the first waveguide and forms at least in part an end opposite to the first port end of the first waveguide. In some versions the first curved side of the first part of the path controller can be curved along a first curved line in the first slot plane, and in planes parallel to the first slot plane along the first curved line in these parallel planes, to the extension of the first curved side. Then suitably the first curved lines, in the parallel planes, are aligned along a straight line parallel to a normal to the first slot plane, or are aligned along a bent line. In other versions the first curved side of the first part of the path controller is curved along a first curved line in the first slot plane, and in planes at an angle to the first slot plane along further curved lines in these planes to the extension of the first curved side. The first curved line can be parabolic, or piecewise parabolic along the first curved side. The first curved side can suitably be symmetrical in relation to a plane defined by the first principal propagation direction and the controller principal propagation direction.

In some embodiments the first waveguide from the at least one first port flares out towards the first part of the path controller between the parallel plates. Then suitably the transmission line path controller controls a propagation path length between the at least one first port to each point in the second port in a predetermined controlled manner such that a predetermined line source is formed in the second port. In some applications the transmission line path controller controls the propagation path length such that the propagation path length is substantially equal, independent of an electromagnetic wave propagation direction in the flared first waveguide.

Sometimes it is suitable that the transmission line structure comprises more than one first port. The at least one first port can have an asymmetrical feed relationship with the first waveguide, or a symmetrical feed relationship with the first waveguide.

The waveguides of the transmission line structure can in some embodiments suitably be aligned such that together the first principal propagation direction, the second principal propagation direction and the controller principal propagation direction, form a plane which is perpendicular with the plates of the waveguides. In other embodiments the first waveguide and the second waveguide are aligned in relation to each other such that a projection of the first principal propagation direction and a projection of the second principal propagation direction onto the slot plane along the slot plane's normal, form an angle with each other separate from zero on the slot plane.

In some embodiments the first part of the path controller is also coupled to the second end of the second waveguide and the controller principal propagation direction is the same as the second principal propagation direction. Then suitably the first curved side of the first part of the path controller extends into the second waveguide and forms at least in part an end opposite the second port end of the second waveguide. The parallel plates of the first waveguide can be parallel with the parallel plates of the second waveguide, or form an angle with the parallel plates of the second waveguide which is different from zero.

In other embodiments the transmission line structure comprises a third parallel-plate waveguide section, and the transmission line path controller comprises a second part comprising a second slot in a second slot plane. The first part of the path controller is further coupled to a first end of the third waveguide. A second end of the third waveguide is coupled to the second part of the path controller. The second part of the path controller is coupled to the second end of the second waveguide. The controller principal propagation direction for an electromagnetic wave entering the at least one first port is in a direction from the first end of the third waveguide towards the second end of the third waveguide. The second slot plane can be parallel to the plates of the third waveguide, or be symmetrically oriented between the parallel plates of the second and third waveguides. The first waveguide and the third waveguide can in some applications be aligned in relation to each other such that a projection of the first principal propagation direction and a projection of the controller principal propagation direction onto a plane parallel to the plates of the first parallel-plate waveguide along the plane's normal, form an angle with each other separate from zero on the plane. In some embodiments the parallel plates of the first waveguide are parallel with the parallel plates of the second waveguide. Suitably the parallel plates of the first waveguide then either form an angle with the parallel plates of the third waveguide which is different from zero, or are parallel with the parallel plates of the third waveguide. In other embodiments the parallel plates of the first waveguide form an angle with the parallel plates of the second waveguide which is different from zero. Then the parallel plates of the first waveguide suitably either form an angle with the parallel plates of the third waveguide which is different from zero, or are parallel with the parallel plates of the third waveguide. Sometimes it is suitable that the parallel plates of the second waveguide are parallel with the parallel plates of the third waveguide.

A side of the second slot furthest away from the second port, can suitably be curved in the second slot plane, forming a second curved side of the second part of the path controller. Then the at least one other curved side of the second slot can be a side opposite the second curved side and can suitably be curved in a similar manner, the second slot will thus form a substantially uniformly formed waveguide slot. The second curved side of the second part of the path controller can then extend into the second waveguide and form at least in part an end opposite the second port end of the second waveguide. In some embodiments the second curved side of the second part of the path controller can then be curved along a second curved line in the second slot plane, and in planes parallel to the second slot plane along the second curved line in these parallel planes to the extension of the second curved side. Then the second curved lines in the parallel planes are suitably either aligned along a straight line parallel to a normal to the second slot plane, or aligned along a bent line. In other embodiments the second curved side of the second part of the path controller can then be curved along a second curved line in the second slot plane, and in planes at an angle to the second slot plane along further curved lines in these planes to the extension of the second curved side. The second curved line can suitably in some embodiments be parabolic. In some embodiments the first curved side and the second curved side are formed such that the path controller forms a Cassegrain structure. In other embodiments the first curved side and the second curved side are formed such that the path controller forms a Gregorian structure.

In the transmission line structure each coupling between a path controller part and a waveguide suitably comprises appropriate matchings. The transmission line structure is suitably of an H-plane type, or of an E-plane type.

The aforementioned objects are also achieved according to the invention by an antenna comprising a transmission line structure according to any one of the above mentioned embodiments

By providing a transmission line structure according to the invention a plurality of advantages over prior art are obtained. A primary purpose of the invention is to enable a compact antenna to be constructed by providing a novel transmission line structure, which transforms one or more point type sources to a line source. This is obtained according to the invention by incorporating a curved slot between and coupling two waveguides together. The two waveguides are coupled together by means of the curved slot such that there is a change in a principal propagation direction in the curved slot. The curved slot is oriented such that there is a curvature perpendicular to the principal propagation direction in the waveguides. The curvature of the curved slot determines the appearance of the line source. According to the invention a bent propagation path and a propagation path length controller are accomplished thus enabling a folded feed network which provides a line source to an antenna. The transmission line structure is easy to construct by means of different waveguide technologies and is suited for both E-plane and H-plane broadband propagation. Other advantages of this invention will become apparent from the detailed description.

### BRIEF DESCRIPTION OF THE DRAWINGS

The invention will now be described in more detail for explanatory, and in no sense limiting, purposes, with reference to the following figures, in which

FIG. 1 illustrates an E-plane waveguide path length adjuster according to the invention in a plate structure,

FIG. 2 illustrates an H-plane waveguide path length adjuster according to the invention in a plate structure,

FIG. 3A-3C illustrate further examples of E-plane waveguide path length adjusters according to the invention in a plate structure, with and without a first port matching,

FIG. 4A-4B illustrate still further examples of E-plane waveguide path length adjusters according to the invention in a plate structure, with matchings of path controllers,

FIG. 5 illustrates an example of a Cassegrain type E-plane waveguide path length adjuster according to the invention in a plate structure,

FIG. 6 illustrates an E-plane waveguide path length adjuster with an offset first waveguide into a path controller according to the invention in a plate structure,

FIG. 7 illustrates an E-plane waveguide path length adjuster with two first ports into a first waveguide according to the invention in a plate structure,

FIG. 8A illustrates separate parts of an H-plane waveguide path length adjuster according to the invention in a conventional waveguide structure,

FIG. 8B-8C illustrate an H-plane waveguide path length adjuster according to the invention in a conventional waveguide structure,

FIG. 9A-9B illustrate an E-plane waveguide path length adjuster according to the invention in a conventional waveguide structure,

FIG. 10 illustrates an E-plane waveguide path length adjuster where a first waveguide is not parallel with a second waveguide according to the invention in a conventional waveguide structure,

FIG. 11 illustrates a baffle antenna with an E-plane waveguide path length adjuster according to the invention in a conventional waveguide structure,

FIG. 12 illustrates a reflector antenna with an E-plane waveguide path length adjuster according to the invention in a conventional waveguide structure,

FIG. 13 illustrates a double reflector antenna with an E-plane waveguide path length adjuster with two second waveguides according to the invention in a conventional waveguide structure.

### DETAILED DESCRIPTION

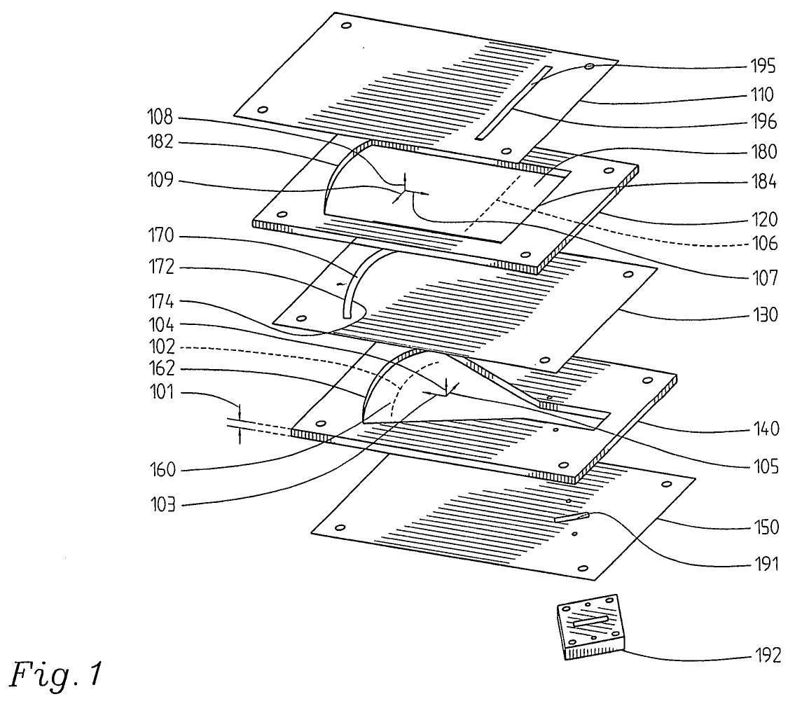

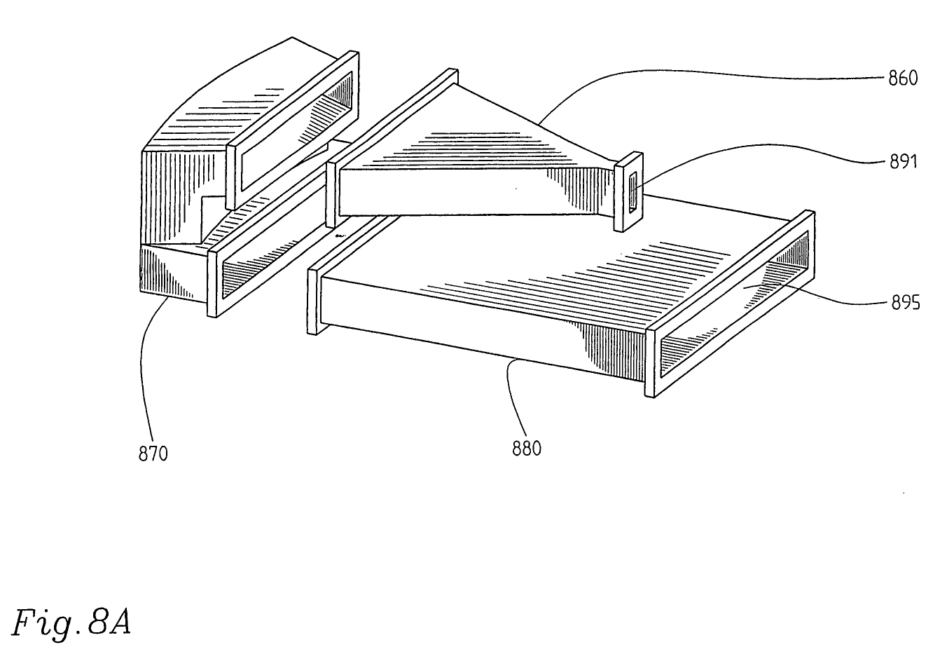

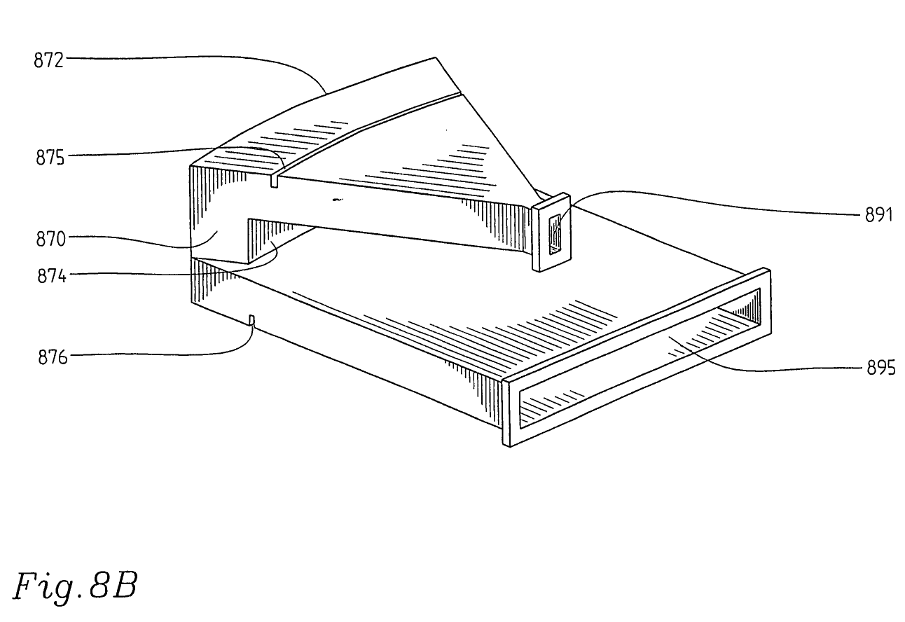

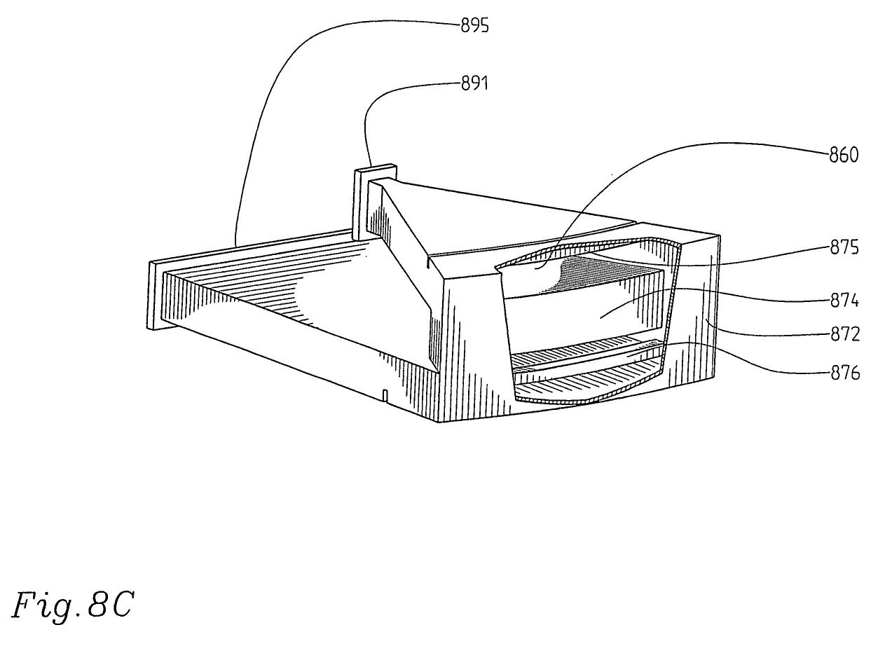

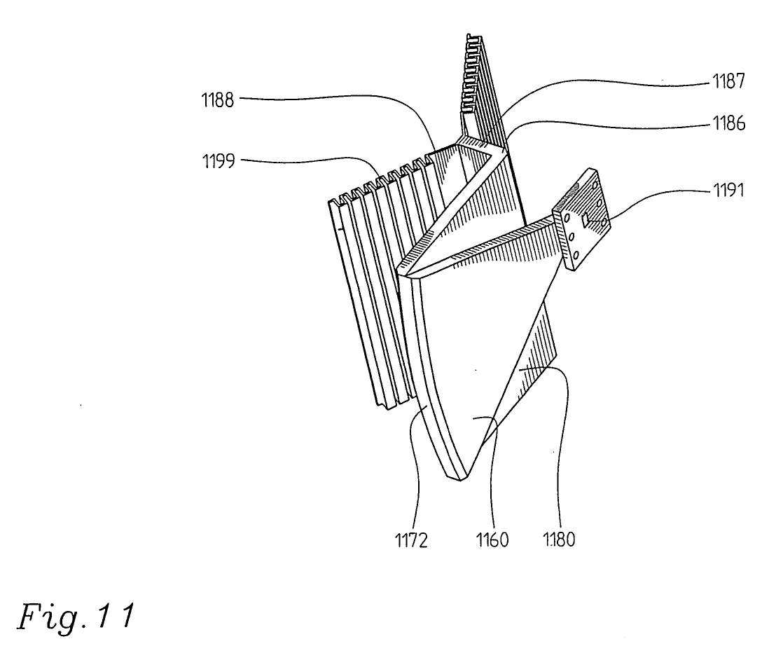

In order to clarify the method and device according to the invention, some examples of its use will now be described in connection with FIGS. 1 to 13. FIGS. 1 to 7 illustrate different waveguide path length adjusters according to the invention in a plate structure. FIGS. 8 to 10 illustrate different waveguide path length adjusters according to the invention in a conventional waveguide structure. FIGS. 11 to 13 illustrate different antenna structures according to the invention. Waveguide path length adjusters according to the invention can be made in any desired waveguide transmission line structure technique, such as in a plate structure technique, in a conventional waveguide structure technique, or in a printed circuit board technique. Printed circuit board technology is especially suitable for compact E-plane waveguide path length adjusters and antenna structures according to the invention, for example as an antenna part of a car radar. Further, the illustrated waveguides are assumed to have air or another gas as a dielectric, but the invention is by no means restricted to air or gas as a dielectric. A waveguide path length adjuster or an antenna structure according to the invention made by printed circuit board technology will, at least in part, have the carrier material of the printed circuit board as a dielectric. A conventional waveguide structure can also be filled with a non-gaseous dielectric.

FIG. 1 illustrates an E-plane waveguide path length adjuster according to the invention in a plate structure. The manufacturing of the plate structure is described in U.S. Pat. No. 6,285,335 and is one of many methods of manufacturing a transmission line structure according to the invention. Illustrated are the individual waveguide and cover plates that are intended to be joined, sandwiched, together before use. According to this transmission line structure, there are a number of waveguide plates 120, 140, and a number of cover/interface plates 110, 130, 150. The thickness 101 of the waveguide plates 120, 140, are not necessarily the same for all of the waveguide plates 120, 140. The cover/interface plates 110, 130, 150, can be of any desired thickness, the properties of the invention are not changed with the thickness of these, and they are therefore only illustrated as thin plates.

The waveguide path length adjuster according to the invention, here illustrated as an E-plane transmission line, comprises at least one first port 191, of a point source type, and a second port 195, of a line source type. It is to be noted that the waveguide path length adjuster according to the invention is completely bi-directional, i.e. the first port can be a source feed for something connected to it, or be fed from something connected to it. A normal use would be to connect an antenna, such as a reflector antenna, to the second port and a transceiver to the first port, i.e. the waveguide path length adjuster according to the invention would be used for both transmission and reception. This description will however mainly describe the function of the waveguide path length adjuster according to the invention in situation when an electromagnetic wave is entered at the first port 191.

According to the invention different parts of a wavefront 102, 106 have similar, or in some embodiments substantially equal, path lengths between a first waveguide section 160 and a second waveguide section 180 enabling one or more point type sources 191 to be transformed into a line source 195, and vice versa. According to the invention this is accomplished by a waveguide slot 170 comprising two curved sides 172, 174, that is arranged between and which slot 170, in a waveguide manner, couples a first parallel waveguide section 160 and a second parallel waveguide section 180. According to this example of FIG. 1, an electromagnetic wave is entered through a mechanical coupling 192, to a first port 191 in a plate 150, which plate is also a first parallel plate of a first parallel plate waveguide section 160 of waveguide plate 140. The electromagnetic wave having entered the cavity 160 of the first parallel plate waveguide section will propagate in a principal propagation direction 103 away from the first port 191 with an electrical, E, field 104 aligned with the thickness 101 of the first parallel plate waveguide section plate 140 and a magnetic, H, field 105, perpendicular to both the propagation direction 103 and the E-field 104. The principal propagation direction 103 is the vector sum of all individual propagation directions along the wavefront 102, a sort of mean direction of the wavefront 102.

When the wavefront 102 has reached the end 162 of the first parallel plate waveguide section 160 furthest away from the first port 191, then the wavefront 102 will propagate through a waveguide slot 170 with two curved sides 172, 174. The width of the slot 170, i.e. the distance between the curved sides 172, 174, is of the same magnitude as the thickness 101 of the waveguide plates 120,140. The slot 170 is also preferably at least substantially of similar width along the whole slot. The slot plate 130 is in this example also a first parallel plate of the second parallel plate waveguide section 180 of waveguide plate 120 and a second parallel plate of the first parallel plate waveguide section 160. The curved side 172 of the slot 170 furthest away from the first port 191 is suitably aligned at least in part with the end 162 of the first parallel plate waveguide section 160 and aligned at least in part with an end 182 of the second parallel plate waveguide section 180. This means that the ends 162, 182 are curved the same as the curved side 172 of the slot 170 furthest away from the first port 191, at least in the coupling with the slot 170.

The wavefront 106 that exits the slot 170 into the second parallel plate waveguide section 180 will attain a new principal propagation direction 107 away from the curved slot 170. The electrical, E, field 108 is still aligned with the thickness 101 of the waveguide plate and the magnetic, H, field 109 is perpendicular to both the propagation direction 107 and the E-field 108. The shape of the wavefront 106 will depend on the shape of the curved slot 170, i.e. when different parts of the incident wavefront 102 hits the corresponding place of the curved slot 170. If, as illustrated, the incident wavefront 102 has originated from a point source and the curved slot 170 is parabolic, then the resulting wavefront 106 will be a perfect straight line. Thus by adjusting the shape of the slot 170 and the relationship of the first port 191 or ports with the slot 170, different line sources can be created. The wavefront 106 will then propagate 107 towards a second end 184, away from the curved slot 170 and exit the waveguide path length adjuster according to the invention through the second port 195. The second port 195 is a part of a plate 110 that is also a second parallel plate of the second parallel plate waveguide section. A side 196 of the second port 195, furthest away from the curved slot 170, is typically aligned with the second end 184 of the second parallel plate waveguide section 180. The length of the second parallel plate waveguide section is, in this example, such that the first port 191 and the second port 195 align.

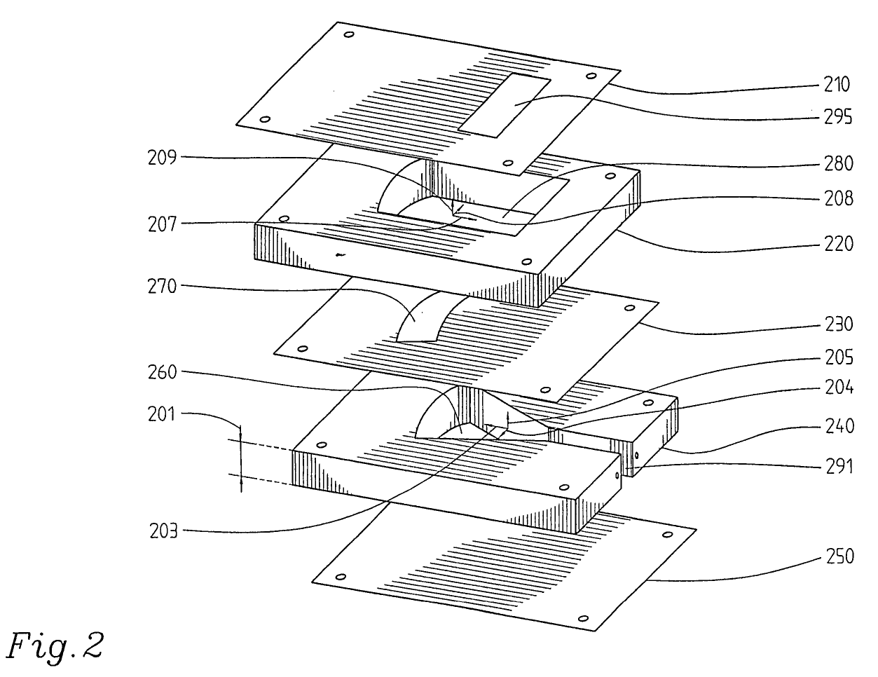

The waveguide path length adjuster according to the invention may be varied in a number of different ways. FIG. 2 illustrates an H-plane waveguide path length adjuster according to the invention in a plate structure. The plate structure comprises waveguide plates 220, 240 and port, slot, and cover plates 210, 230, 250. The first port 291 enters the plate 240 of the first parallel plate waveguide section from the short end instead of through a cover plate 250. An electromagnetic wave entering the first port 291 will have its principal propagation direction 203 towards a curved waveguide slot 270 located between and coupling the first parallel plate waveguide section 260 with a second parallel plate waveguide section 280. The wave will continue in the second parallel plate waveguide section 280 in a new principal propagation direction 207 towards a second port 295. In relation to FIG. 1, the E-field 204, 208 and the H-field 205, 209 have altered directions. Further the thickness 201 of the waveguide plates 220, 240 and the width of the curved slot 270, the first port 291 and the second port 295 have increased to typically more than one half free space wavelength.

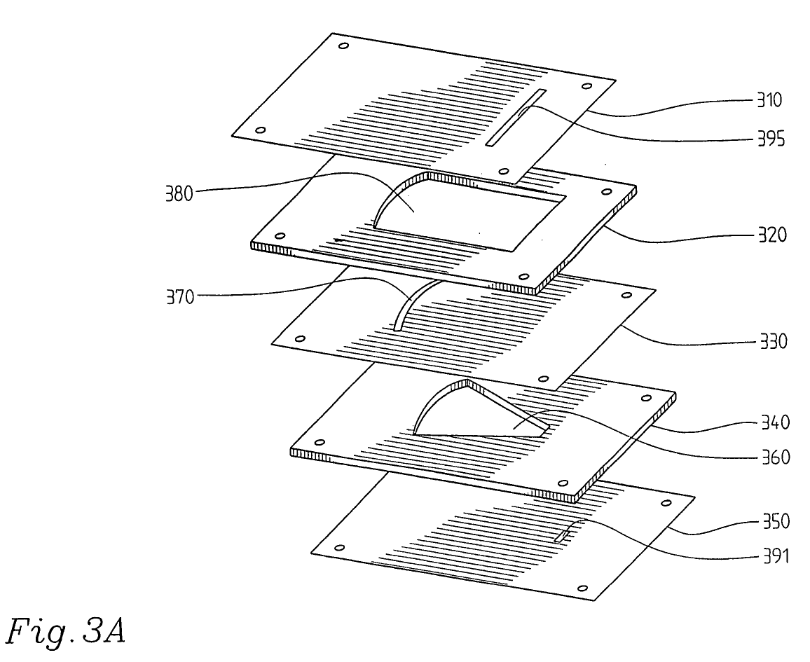

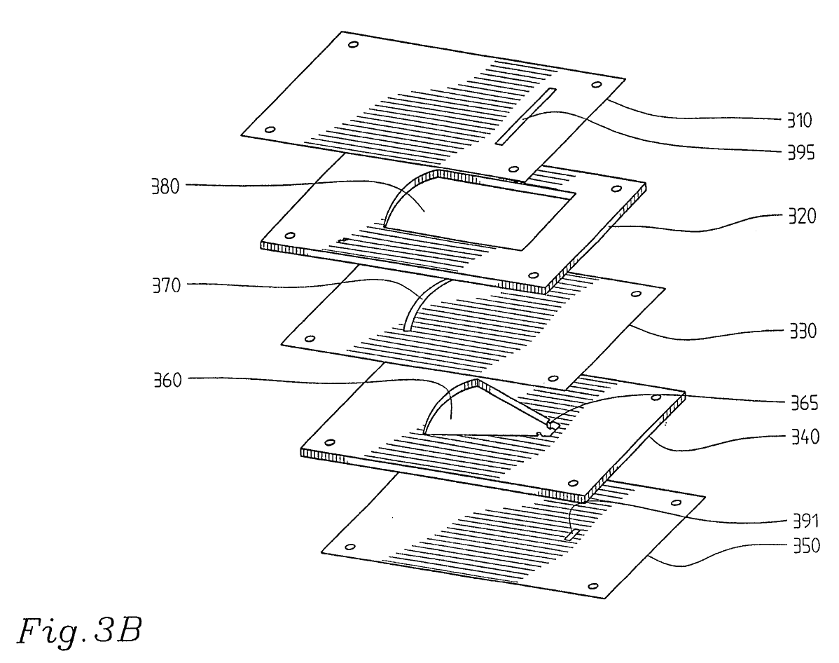

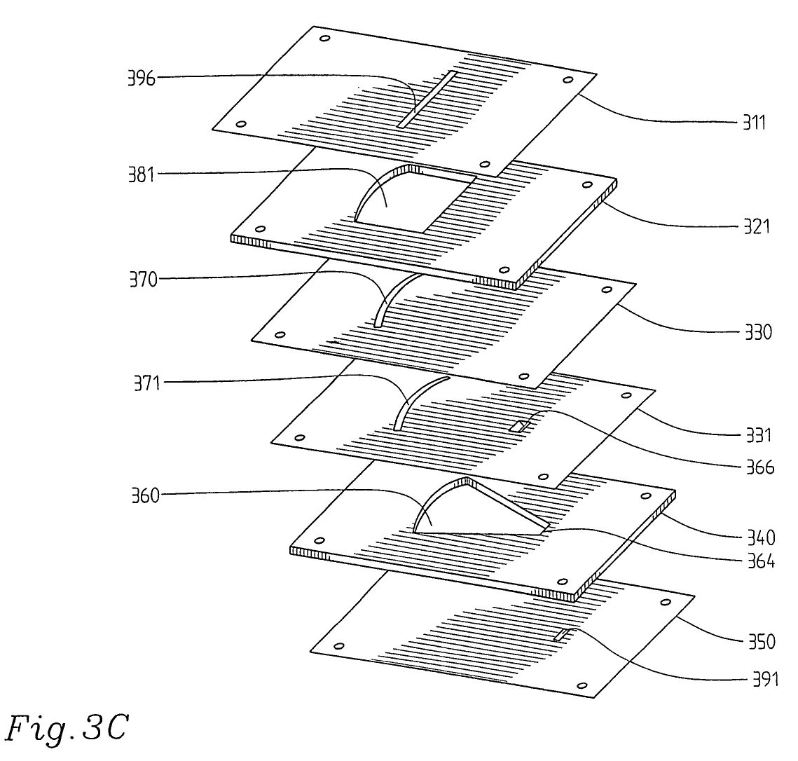

FIGS. 3A to 3C illustrate further examples of E-plane waveguide path length adjusters according to the invention in a plate structure, with and without a first port matching. The plate structures comprise waveguide plates 320, 340 with corresponding waveguide cavities 360, 380 and port, slot, and cover plates 310, 330, 350 with corresponding first port 391, second port 395, and curved slot 370. FIG. 3A illustrates a similar waveguide path length adjuster to that of FIG. 1, with another type of first port 391. FIG. 3B illustrates a waveguide path length adjuster such as the one illustrated in FIG. 3A with the addition of first port matching 365 protrusions. There are a number of ways the first port 391 can be properly matched to the first parallel plate waveguide section 360. FIG. 3C illustrates another method of matching the first port 391 to the first parallel plate waveguide section 360. This second method creates a slanted end of the first parallel plate waveguide section 360 end 364 closest to the first port 391 by means of a cut out 366 in an additional slot plate 331. The additional slot plate 331 will also comprise a curved slot 371, which is to align with the curved slot 370 of the slot plate 330. The cut out 366 will reach approximately half way down the end 364 when the plates are assembled. A slanted end of the first parallel plate waveguide section 360 at the first port 391 end 364 could be accomplished in other manners, such as, in a waveguide plate structure, machining the end 364 to a desired shape. FIG. 3C also illustrates a shorter second parallel plate waveguide section 381 in a corresponding waveguide plate 321 to thereby be able to place a second port 396 in a corresponding plate 311 at a needed location. This relocation of the ports is possible since there is no radiation within the waveguide path length adjuster according to the invention.

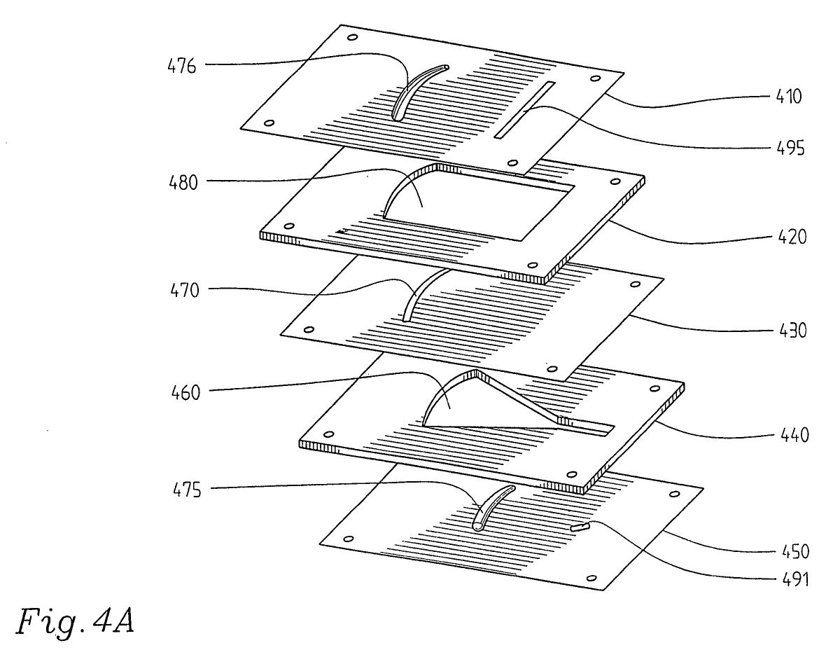

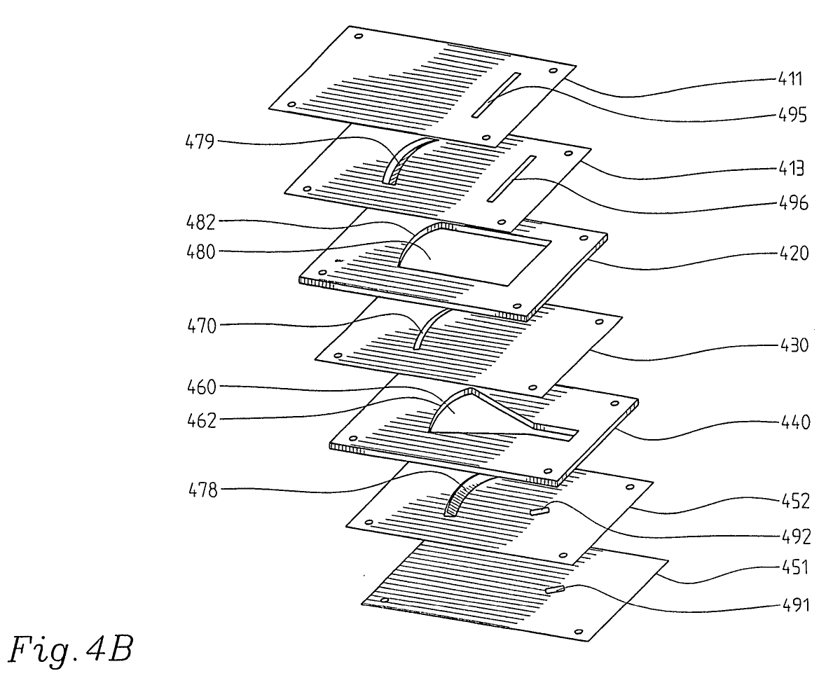

FIGS. 4A and 4B illustrate still further examples of E-plane waveguide path length adjusters according to the invention in a plate structure, with different matchings of the path controllers with the coupled parallel plate waveguide sections. As previously, the plate structures comprise waveguide plates 420, 440 with corresponding waveguide cavities 460, 480 and port, slot, and cover plates 410, 430, 450 with corresponding first port 491, second port 495, and curved slot 470. FIG. 4A illustrate a first example of matching the curved slot 470 to each one of the parallel plate waveguide sections 460, 480, where indentations 475, 476 into each respective waveguide cavity 460, 480 in the vicinity of the assembled location of the curved slot 470. FIG. 4B illustrate a second example where cut outs 478, 479 are used. The cut outs 478, 479 are such that they, when the structure is assembled, extend into a respective cavity 460, 480 and align preferably approximately half way down onto a respective waveguide end 462, 482 by the curved slot 470. This will then create a proper transition between the curved slot 470 and each respective waveguide 460, 480. Due to the use of cut outs 478, 479 in the first port 492 plate 452 and the second port 496 plate 413, then it is preferably suitable to use additional cover plates 451, 411 with corresponding ports 491, 495.

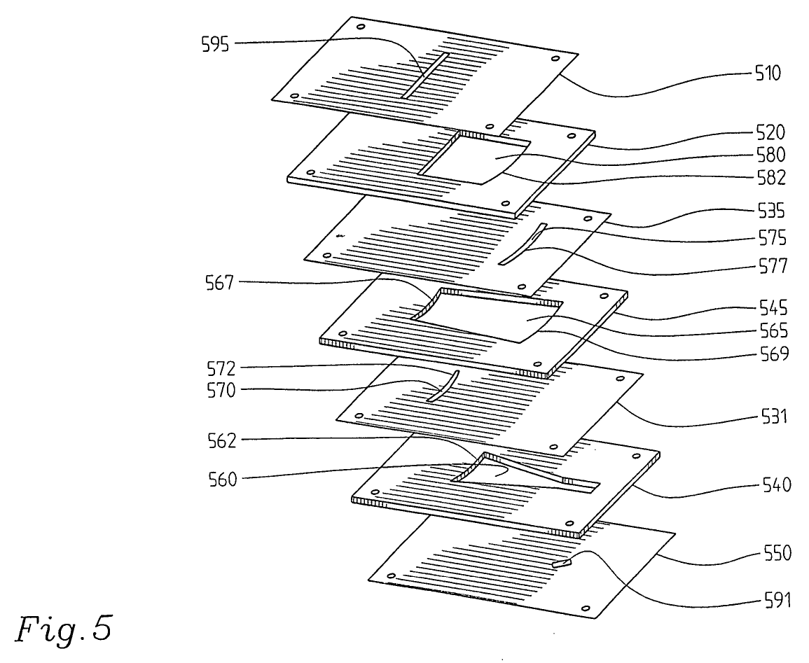

The invention is not restricted to the use of only one curved slot with corresponding coupled waveguides. FIG. 5 illustrates an example of a Cassegrain type E-plane waveguide path length adjuster according to the invention in a plate structure. In this example the transformation between one, or more, point type sources and a line source is performed in two stages, each stage comprising a curved slot according to the invention. The structure comprises a first 560, a second 580 and a third 565 parallel plate waveguide section 560, 565, 580 formed by corresponding waveguide plates 540, 545, 520 and cover plates 510, 535, 531, 550. The cover plates in this example are shared among different waveguides, ports 591, 595 and curved slots 570, 575.

The third parallel plate waveguide section 565 could also be called an intermediate waveguide since it is placed in between the first parallel plate waveguide section 560 and the second parallel plate waveguide section 580 in the propagation path. An electromagnetic wave entered through the first port 591 will propagate away from the first port 591 in the first parallel plate waveguide section 560 towards a slot end 562 and a first curved slot 570. The slot end 562 and a first slot end 567 of the third waveguide 565 will preferably be aligned with a curved side 572 of the first curved slot 570 furthest away from the first port 591, at least by the first curved slot 570. The propagation path length that the electromagnetic wave has propagated has been at least partially adjusted in relation to where the wave entered the first curved slot 570. The electromagnetic wave will continue propagation in the third waveguide 565 from the first slot end 567 towards a second slot end 569 and a second curved slot 575. The second slot end 569 and a slot end 582 of the second waveguide 580 will preferably be aligned with a curved side 577 of the second curved slot 577 furthest away from the first curved slot 570, at least by the second curved slot 577. The propagation path length that the electromagnetic wave has propagated has been finally adjusted in relation to where the wave entered the second curved slot 577. The electromagnetic wave will continue propagation in the second waveguide 580 from the slot end 582 towards the second port 595. At each curved slot 570, 577 the propagation path length of the electromagnetic wave is adjusted, i.e. the wave's wavefront shape is changed by each curved slot 570, 577. Another type of two curved slots and three waveguides propagation path length adjustment structure is the Gregorian. The invention is not limited to two curved slots structures.

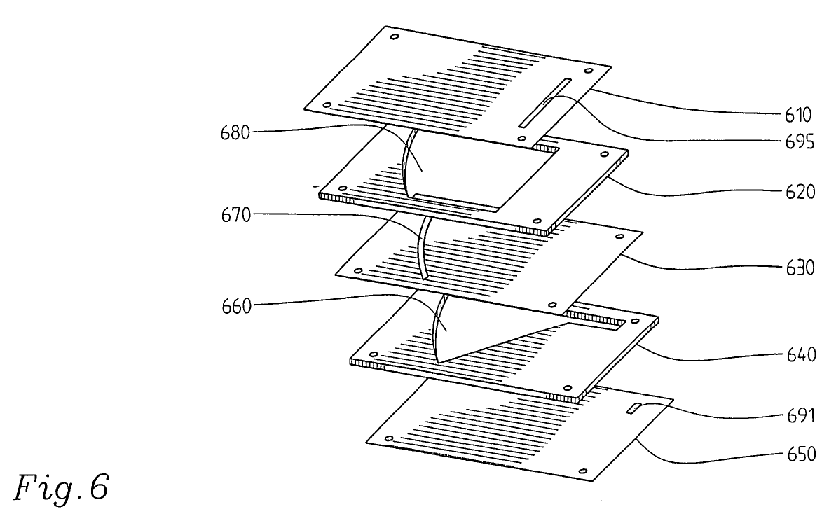

Another variation of a waveguide path length adjuster according to the invention is illustrated in FIG. 6. FIG. 6 illustrates an E-plane waveguide path length adjuster between a first port 691 and a second port 695 with an offset first waveguide 660 into a path controller 670 according to the invention in a plate structure 610, 620, 630, 640, 650. Here it can be seen that a principal propagation direction of a first waveguide 660, in the plane of the first waveguide plate 640, is not parallel with a principal propagation direction of a second waveguide 680, in the plane of the second waveguide plate 620.

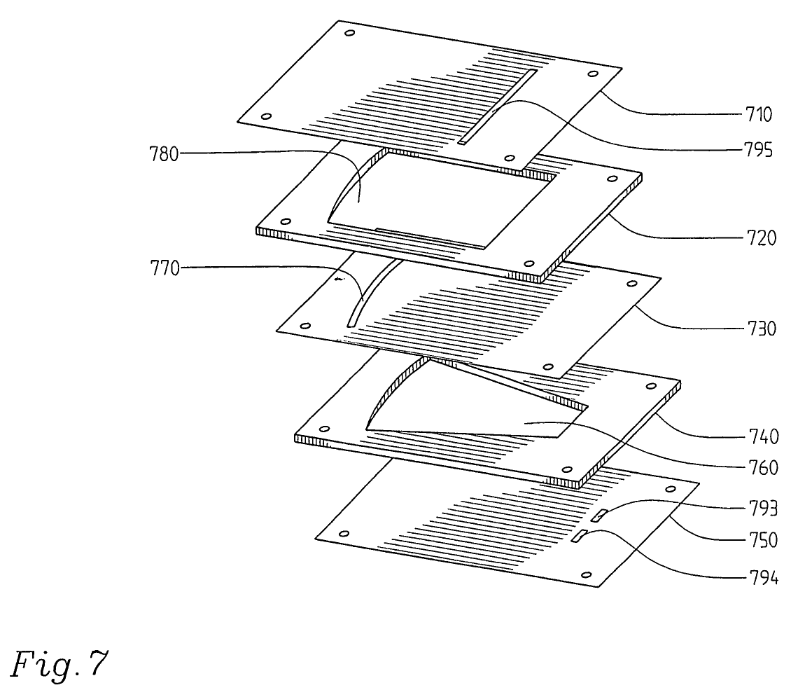

FIG. 7 illustrates an E-plane waveguide path length adjuster with two first ports 793, 794 into a first waveguide 760 through a curved slot 770 into a second waveguide 780 to a second port 795 according to the invention in a plate structure 710, 720, 730, 740, 750. The curved slot 770 will commonly be adapted in its curvature to handle the multi curvature wavefront from the two or more first ports 793, 794.

Other common waveguide constructional techniques are illustrated in FIGS. 8 to 13. FIG. 8A illustrates the three basic separate parts 860, 870, 880 of a basic H-plane waveguide path length adjuster according to the invention in a conventional waveguide structure. A basic waveguide path length adjuster according to the invention comprises a path controller 870, a first parallel plate waveguide section 860, and a second parallel plate waveguide section 880. The path controller 870, is basically a slot with two curved sides, which slot is arranged to couple the first waveguide 860 with the second waveguide 880. The first waveguide 860 comprises a first port 891 at one end, and the other end is arranged to be coupled to the path controller 870. The second waveguide 880 comprises a second port 895 at one end, and the other end is arranged to be coupled to the path controller 870. FIGS. 8B and 8C illustrate how such an H-plane waveguide path length adjuster according to the invention can look like when assembled. Here the two curved sides 872, 874 of the curved slot 870 are clearly visible. The H-plane waveguide path length adjuster according to the example of FIG. 8B has slot matchings 875, 876 in the form of indentations on each waveguide in the vicinity of the curved slot 870 and at least partially of the same type of curvature as the curved sides 872, 874. FIG. 8C illustrate the same H-plane waveguide path length adjuster as that of FIG. 8B, but from a different angle and with a part of the external curved side cut away. To be noted is that the curved slot 870 is not limited to a thin plate as illustrated in FIGS. 1 to 7.

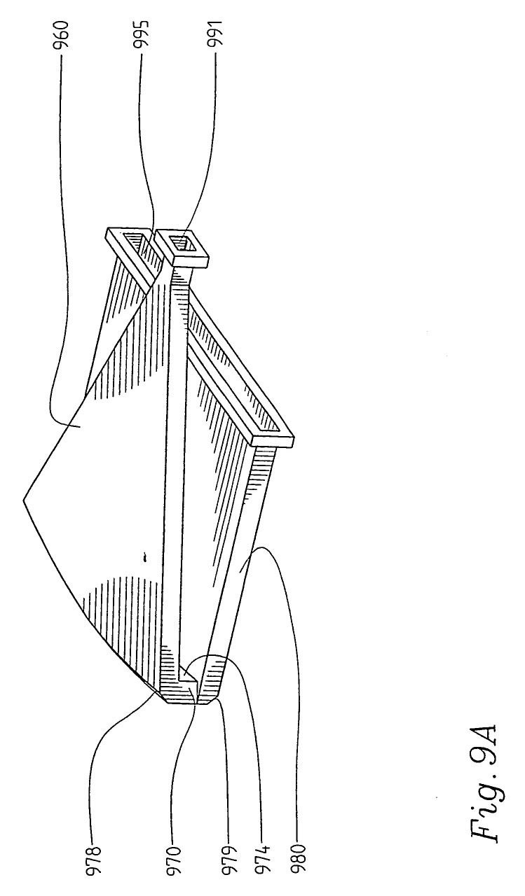

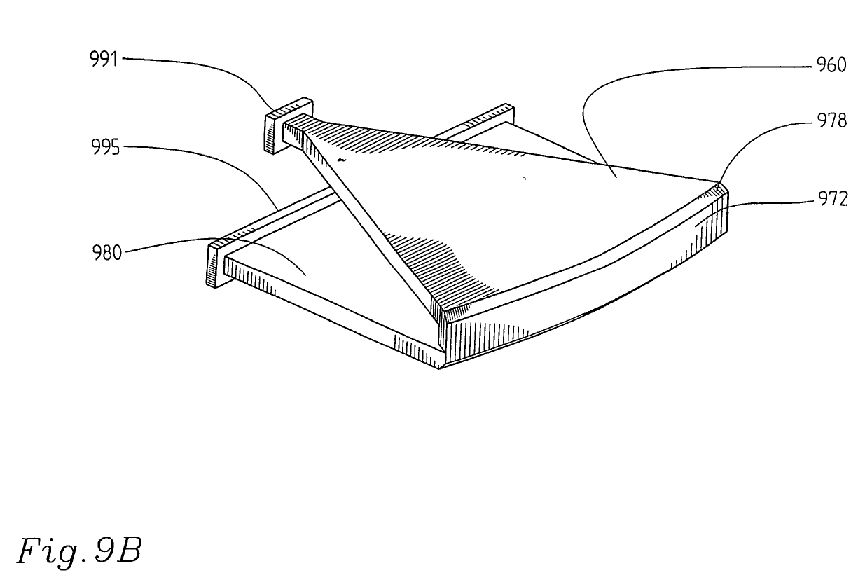

FIGS. 9A and 9B illustrate an E-plane waveguide path length adjuster according to the invention in a conventional waveguide structure from different views. The adjuster comprises a first parallel plate waveguide section 960 with a first port 991, a path controller 970 with two curved sides 972, 974, and a second parallel plate waveguide section 980 with a second port 995. FIGS. 9A and 9B illustrate a further method of matching the waveguides to the curved slot. This matching type is accomplished by having a smoother transitioning from the outer curved side 972 of the curved slot 970 to each waveguide's outer plate than 90° edges, for example as illustrated, 45° sections 978, 979.

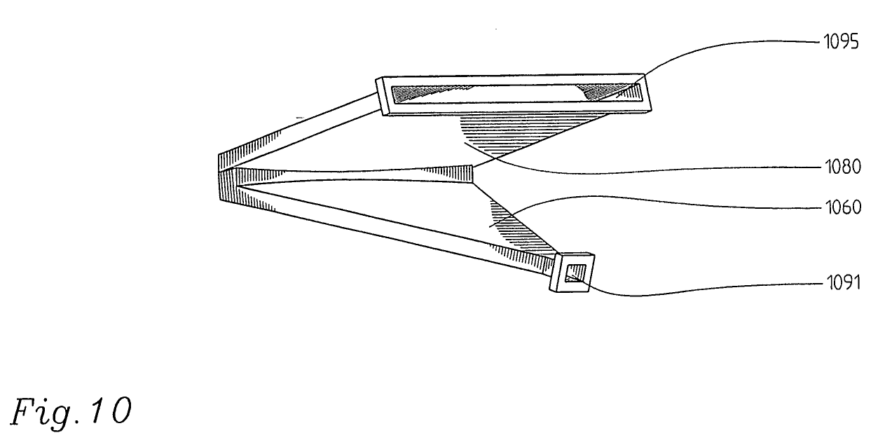

The waveguide path length adjusters illustrated so far have had the concerned waveguides parallel with each other. This will in most cases be the most practical and useful way of constructing the invention. However in some circumstances it might be useful and even necessary to have the parallel plates of one waveguide at an angle with the parallel plates of another waveguide. FIG. 10 illustrates an E-plane waveguide path length adjuster where a first waveguide 1060 with its first port 1091 is not parallel with a second waveguide 1080 with its second port 1095.

FIG. 11 illustrates a baffle antenna with an E-plane waveguide path length adjuster according to the invention in a conventional waveguide structure. Typically a transceiver, a receiver or a transmitter would be connected to the antenna via a first port 1191 of the antenna. The antenna further comprises a waveguide path length adjuster with a first waveguide 1160, a second waveguide 1180 and a path controller, a slot with curved sides coupling the first and second waveguides, of which only an outer curved side 1172 is visible. To be noted is that the curved slot is here reduced to one or two plates. A 90° waveguide bend 1186 is connected to the second waveguide 1180. Thereafter a feed waveguide 1187 is a radiating line source, which in conjunction with baffles 1188 and beam shaping corrugations 1199 act as an antenna.

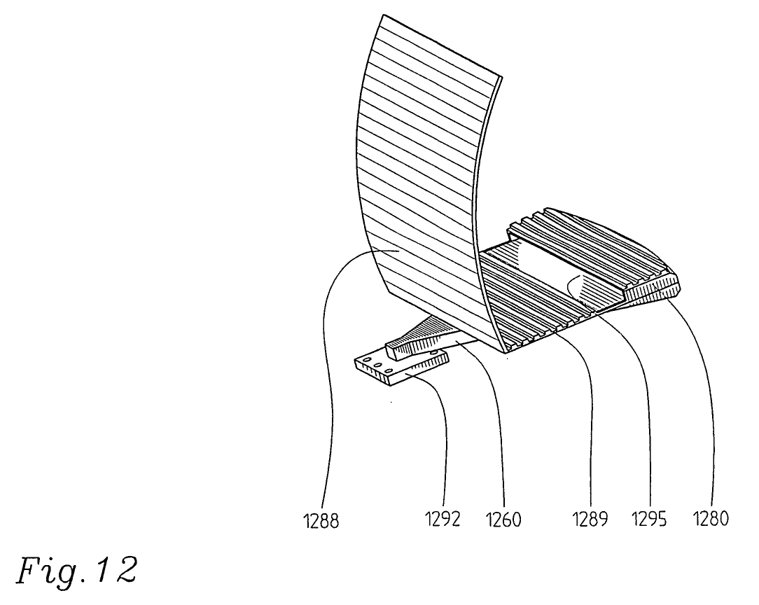

FIG. 12 illustrates a reflector antenna with an E-plane waveguide path length adjuster according to the invention in a conventional waveguide structure. The antenna is connected by means of a mechanical coupling 1292 to a first port. The antenna further comprises a path controller, a first 1260 and a second 1280 waveguide, the second waveguide 1280 comprises a second port 1295 that is the radiating element. Radiated electromagnetic waves are reflected on an antenna reflector 1288. If the reflector 1288 is parabolic with its focus at the second port 1295, then a locally plane two-dimensional wavefront can be accomplished. For good antenna characteristics, the antenna is covered with corrugations 1289 at vital locations.

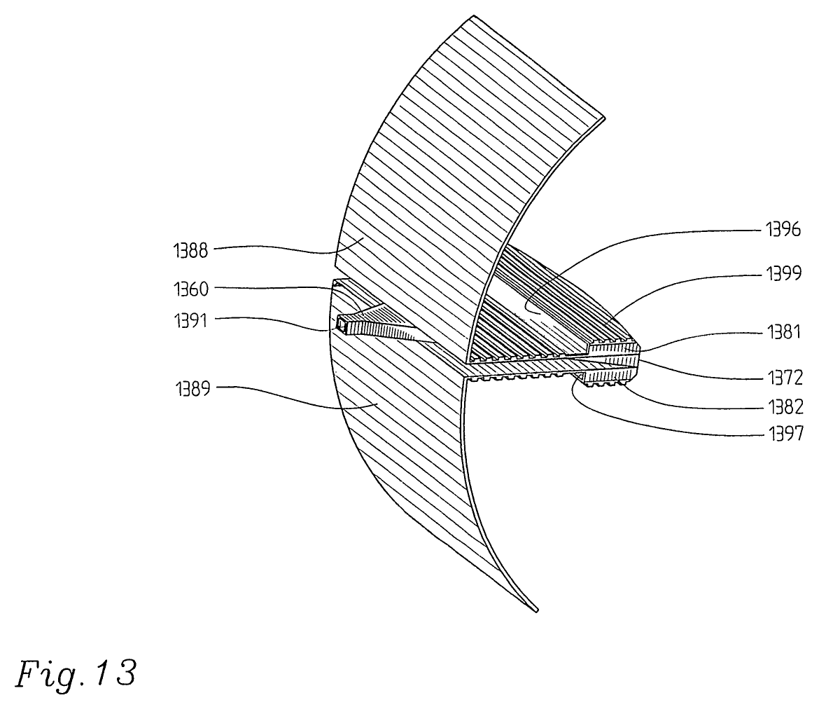

FIG. 13 illustrates a double-sided reflector antenna with an E-plane waveguide path length adjuster with two second waveguides according to the invention in a conventional waveguide structure. The antenna is connected via a first port 1391 of a first waveguide 1360. The first waveguide 1360 is coupled to a path controller, which in this example comprises two curved slots with a common outer curved side 1372. Each one of the curved slots is coupled to a respective second waveguide 1382, 1399, which in turn each comprise a radiating second port 1396, 1397. The radiating second ports 1396, 1397 radiate onto a respective reflector 1388, 1389. Corrugations 1399 are placed on the antenna at vital locations.

The invention is based on the basic inventive idea of coupling a first and a second waveguide together via a curved slot to thereby be able to adjust a shape of a wavefront. The curved slot creates a waveguide path length adjuster according to the invention, which in most applications will adjust the lengths of different paths from a point source to a line source to be the same. The invention is not restricted to the above described embodiments, but may be varied within the scope of the following claims.
FIG. 1—illustrates an E-plane waveguide path length adjuster according to the invention in a plate structure,
101 thickness of waveguide plates, which can be different for the different plates,
102 wavefront in first parallel plate waveguide section,
103 propagation direction of an electromagnetic wave entered at the first port,
104 E, electric field,
105 H, magnetic field,
106 wavefront in second parallel plate waveguide section,
107 propagation direction of an electromagnetic wave entered at the first port,
108 E, electric field,
109 H, magnetic field,
110 plate of a second port and a second parallel plate of a second parallel plate waveguide section,
120 plate of the second parallel plate waveguide section,
130 slot plate and a first parallel plate of the second parallel plate waveguide section and a second parallel plate of a first parallel plate waveguide section,
140 plate of the first parallel plate waveguide section,
150 plate of a first port and a first parallel plate of the first parallel plate waveguide section,
160 cavity of the first parallel plate waveguide section,
162 part of path controller, at least partially curved end opposite first port,
170 part of path controller, waveguide slot with two curved sides,
172 first curved side of slot,
174 second curved side of slot,
180 cavity of the second parallel plate waveguide section,
182 part of path controller, at least partially curved end opposite second port,
184 end of second port opposite at least partially curved end,
191 first port,
192 mechanical first port coupling,
195 second port, line source,
196 edge of second port furthest away from at least partially curved end of second parallel plate waveguide section.
FIG. 2—illustrates an H-plane waveguide path length adjuster according to the invention in a plate structure,
201 thickness of waveguide plates,
203 propagation direction of an electromagnetic wave entered at the first port,
204 E, electric field,
205 H, magnetic field,
207 propagation direction of an electromagnetic wave entered at the first port,
208 E, electric field,
209 H, magnetic field,
210 plate of a second port and a second parallel plate of a second parallel plate waveguide section,
220 plate of the second parallel plate waveguide section,
230 slot plate and a first parallel plate of the second parallel plate waveguide section and a second parallel plate of a first parallel plate waveguide section,
240 plate of the first parallel plate waveguide section,
250 plate of a first parallel plate of the first parallel plate waveguide section,
260 cavity of the first parallel plate waveguide section,
270 part of path controller, waveguide slot with two curved sides,
280 cavity of the second parallel plate waveguide section,
291 first port,
295 second port, line source.
FIGS. 3A to 3C—illustrate further examples of E-plane waveguide path length adjusters according to the invention in a plate structure, with and without a first port matching,
310 plate of a second port and a second parallel plate of a second parallel plate waveguide section,
311 alternative plate of a second port and a shorter second parallel plate of a second parallel plate waveguide section,
320 plate of the second parallel plate waveguide section,
321 alternative plate of the shorter second parallel plate waveguide section,
330 slot plate and a first parallel plate of the second parallel plate waveguide section and possibly a second parallel plate of a first parallel plate waveguide section,
331 additional slot plate and a second parallel plate of a first parallel plate waveguide section, and an alternative first port matching,
340 plate of the first parallel plate waveguide section,
350 plate of a first port and a first parallel plate of the first parallel plate waveguide section,
360 cavity of the first parallel plate waveguide section,
364 first parallel plate waveguide edge of first port end,
365 first port matching protrusions,
366 first port matching, punched/cut out in additional slot plate, reaches approximately half way down on first waveguide edge of first port end when assembled,
370 part of path controller, slot with two curved sides,
371 part of path controller, additional slot with two curved sides in additional slot plate,
380 cavity of the second parallel plate waveguide section,
381 alternative cavity of the shorter second parallel plate waveguide section,
391 first port,
395 second port, line source.
396 alternatively placed second port in alternative plate of second port.
FIGS. 4A and 4B—illustrate still further examples of E-plane waveguide path length adjusters according to the invention in a plate structure, with matchings of path controllers,
410 plate of a second port and a second parallel plate of a second parallel plate waveguide section,
411 alternative plate of a second port,
413 plate of a second port part, a second parallel plate of a second parallel plate waveguide section, and a slot matching part,
420 plate of the second parallel plate waveguide section,
430 slot plate and a first parallel plate of the second parallel plate waveguide section and a second parallel plate of a first parallel plate waveguide section,
440 plate of the first parallel plate waveguide section,
450 plate of a first port and a first parallel plate of the first parallel plate waveguide section,
451 alternative plate of a first port,
452 plate of a first port part, a first parallel plate of the first parallel plate waveguide section, and a slot matching part,
460 cavity of the first parallel plate waveguide section,
462 part of path controller, at least partially curved end opposite first port,
470 part of path controller, slot with two curved sides,
475 first example of matching of slot in relation to first parallel plate wave guide section, as an indentation in the first port plate/first parallel plate of the first parallel plate waveguide section, protruding into the cavity of the first parallel plate waveguide section,
476 first example of matching of slot in relation to second parallel plate wave guide section, as an indentation of the second port plate/second parallel plate of the second parallel plate waveguide section, protruding into the cavity of the second parallel plate waveguide section,
478 second example of matching of slot in relation to first parallel plate wave guide section, punched/cut out of the first parallel plate of the first parallel plate waveguide section, and reaches approximately half way down on the path controller/first waveguide edge opposite the first port end when assembled,
479 second example of matching of slot in relation to second parallel plate wave guide section, punched/cut out of the second parallel plate waveguide section, and reaches approximately half way down on the path controller/second waveguide edge opposite second port end when assembled,
480 cavity of the second parallel plate waveguide section,
482 part of path controller, at least partially curved end opposite second port,
491 first port,
492 first port part,
495 second port, line source,
496 second port part.
FIG. 5—illustrates an example of a Cassegrain type E-plane waveguide path length adjuster according to the invention in a plate structure,
510 plate of a second port and a second parallel plate of a second parallel plate waveguide section,
520 plate of the second parallel plate waveguide section,
531 first slot plate and a first parallel plate of the third parallel plate waveguide section and a second parallel plate of a first parallel plate waveguide section,
535 second slot plate and a first parallel plate of the second parallel plate waveguide section and a second parallel plate of a third parallel plate waveguide section,
545 plate of the third parallel plate waveguide section,
540 plate of the first parallel plate waveguide section,
550 plate of a first port and a first parallel plate of the first parallel plate waveguide section,
560 cavity of the first parallel plate waveguide section,
562 part of first path controller, at least partially curved end opposite first port,
565 cavity of the third parallel plate waveguide section,
567 part of first path controller, at least partially curved end at first slot end,
569 part of second path controller, at least partially curved end at second slot end,
570 part of first path controller, first slot with two curved sides,
572 part of first path controller, curved side of first slot,
575 part of second path controller, second slot with two curved sides,
577 part of second path controller, curved side of second slot,
580 cavity of the second parallel plate waveguide section,
582 part of second path controller, at least partially curved end opposite second port,
591 first port,
595 second port, line source.
FIG. 6—illustrates an E-plane waveguide path length adjuster with an offset first waveguide into a path controller according to the invention in a plate structure,
610 plate of a second port and a second parallel plate of a second parallel plate waveguide section,
620 plate of the second parallel plate waveguide section,
630 slot plate and a first parallel plate of the second parallel plate waveguide section and a second parallel plate of a first parallel plate waveguide section,
640 plate of the first parallel plate waveguide section,
650 plate of a first port and a first parallel plate of the first parallel plate waveguide section,
660 cavity of the first parallel plate waveguide section,
670 part of path controller, slot with two curved sides,
680 cavity of the second parallel plate waveguide section,
691 first port,
695 second port, line source.
FIG. 7—illustrates an E-plane waveguide path length adjuster with two first ports into a first waveguide according to the invention in a plate structure,
710 plate of a second port and a second parallel plate of a second parallel plate waveguide section,
720 plate of the second parallel plate waveguide section,
730 slot plate and a first parallel plate of the second parallel plate waveguide section and a second parallel plate of a first parallel plate waveguide section,
740 plate of the first parallel plate waveguide section,
750 plate of a first port and a first parallel plate of the first parallel plate waveguide section,
760 cavity of the first parallel plate waveguide section,
770 part of path controller, slot with two curved sides,
780 cavity of the second parallel plate waveguide section,
793 first first port,
794 second first port,
795 second port, line source.
FIG. 8A—illustrates separate parts of an H-plane waveguide path length adjuster according to the invention in a conventional waveguide structure,
FIGS. 8B and 8C—illustrate an H-plane waveguide path length adjuster according to the invention in a conventional waveguide structure,
860 first parallel plate waveguide section,
870 path controller, slot with two curved sides,
872 part of path controller, first curved side of slot,
874 part of path controller, second curved side of slot,
875 matching of slot in relation to first parallel plate wave guide section, as an indentation in the first parallel plate of the first parallel plate waveguide section, protruding into the cavity of the first parallel plate waveguide section,
876 matching of slot in relation to second parallel plate wave guide section, as an indentation of the second parallel plate of the second parallel plate waveguide section, protruding into the cavity of the second parallel plate waveguide section,
880 second parallel plate waveguide section,
891 first port,
895 second port, line source.
FIGS. 9A and 9B—illustrate an E-plane waveguide path length adjuster according to the invention in a conventional waveguide structure,
960 first parallel plate waveguide section,
970 path controller, slot with two curved sides,
972 part of path controller, first curved side of slot,
974 part of path controller, second curved side of slot,
978 matching of slot in relation to first parallel plate wave guide section,
979 matching of slot in relation to second parallel plate wave guide section,
980 second parallel plate waveguide section,
991 first port,
995 second port, line source.
FIG. 10—illustrates an E-plane waveguide path length adjuster where a first waveguide is not parallel with a second waveguide according to the invention in a conventional waveguide structure,
1060 first parallel plate waveguide section,
1080 second parallel plate waveguide section,
1091 first port,
1095 second port, line source.
FIG. 11—illustrates a baffle antenna with an E-plane waveguide path length adjuster according to the invention in a conventional waveguide structure,
1160 first parallel plate waveguide section,
1172 part of path controller, first curved side of slot,
1180 second parallel plate waveguide section,
1186 90° waveguide bend,
1187 feed waveguide,
1188 baffles of antenna,
1191 first port,
1199 corrugations.
FIG. 12—illustrates a reflector antenna with an E-plane waveguide path length adjuster according to the invention in a conventional waveguide structure,
1260 first parallel plate waveguide section,
1280 second parallel plate waveguide section,
1288 antenna reflector,
1289 corrugations,
1292 mechanical first port coupling,
1295 second port, line source.
FIG. 13—illustrates a double sided reflector antenna with an E-plane waveguide path length adjuster with two second waveguides according to the invention in a conventional waveguide structure,
1360 first parallel plate waveguide section,
1372 first curved side of slot,
1381 first second parallel plate waveguide section,
1382 second second parallel plate waveguide section,
1388 first reflector of antenna,
1389 second reflector of antenna,
1391 first port,
1396 first second port, line source,
1397 second second port, line source,
1399 corrugations.

1. A method of transforming between one or more point type sources and a line source in a transmission line structure, characterized in that the method comprises inserting a transmission line path controller between a first parallel-plate waveguide section and a second parallel-plate waveguide section, the transmission line path controller comprising a curved side to which one end of each waveguide is coupled, the transmission line path controller further comprising a waveguide slot, one side of which is a part of the curved side, the waveguide slot further coupling the waveguide ends that are coupled to the transmission line path controller, the method further comprising adjusting the curved side to get a desired path length between each different wave path of the one or more point sources and corresponding location of the line source.

2. A transmission line structure comprising a first parallel-plate waveguide section and at least one first electromagnetic wave port of substantially point character at a first end of the first waveguide, the first waveguide propagating an electromagnetic wave entered at the at least one first port of the first end of the first waveguide towards a second end of the first waveguide in a first principal propagation direction, the structure further comprising a second parallel plate waveguide section and a second electromagnetic wave port of a predetermined line character at a first end of the second waveguide, the second waveguide propagating in a second principal direction between a second end of the second waveguide and the second port of the first end of the second waveguide an electromagnetic wave which is entered at the at least one first port, characterized in that the structure comprises a transmission line path controller which controls a propagation path length of an electromagnetic wave passing through it in relation to where the electromagnetic wave passes through the path controller, a first part of the path controller further changes the first principal propagation direction to a controller principal propagation direction for an electromagnetic wave entering the at least one first port, the first part of the path controller being coupled to the second end of the first waveguide and comprising a first slot in a first slot plane, the first slot having at least two curved sides.

3. The transmission line structure according to claim 2, characterized in that the first slot plane is parallel to the plates of the first waveguide.

4. The transmission line structure according to claim 2, characterized in that the first slot plane is symmetrically oriented in between the first principal propagation direction and the controller principal propagation direction.

5. The transmission line structure according to claim 2, characterized in that the first principal propagation direction and the controller principal propagation direction are parallel.

6. The transmission line structure according to claim 2, characterized in that the first principal propagation direction and the controller principal propagation direction forms an angle between 0° and 180°.

7. The transmission line structure according to claim 2, characterized in that a side of the first slot furthest away from the at least one first port, is curved in the first slot plane, forming a first curved side of the first part of the path controller.

8. The transmission line structure according to claim 7, characterized in that the at least one other curved side of the first slot is a side opposite the first curved side and is curved in a similar manner, the first slot thus forming a substantially uniformly formed waveguide slot.

9. The transmission line structure according to claim 7, characterized in that the first curved side of the first part of the path controller extends into the first waveguide and forms at least in part an end opposite to the first port end of the first waveguide.

10. The transmission line structure according to claim 7, characterized in that the first curved side of the first part of the path controller is curved along a first curved line in the first slot plane, and in planes parallel to the first slot plane along the first curved line in these parallel planes, to the extension of the first curved side.

11. The transmission line structure according to claim 10, characterized in that the first curved lines, in the parallel planes, are aligned along a straight line parallel to a normal to the first slot plane.

12. The transmission line structure according to claim 10, characterized in that the first curved lines in the parallel planes are aligned along a bent line.

13. The transmission line structure according to claim 7, characterized in that the first curved side of the first part of the path controller is curved along a first curved line in the first slot plane, and in planes at an angle to the first slot plane along further curved lines in these planes to the extension of the first curved side.

14. The transmission line structure according claim 10, characterized in that the first curved line is parabolic.

15. The transmission line structure according claim 10, characterized in that the first curved line is piecewise parabolic along the first curved side.

16. The transmission line structure according to claim 7, characterized in that the first curved side is symmetrical in relation to a plane defined by the first principal propagation direction and the controller principal propagation direction.

17. The transmission line structure according to claim 2, characterized in that the first waveguide from the at least one first port flares out towards the first part of the path controller between the parallel plates.

18. The transmission line structure according to claim 17, characterized in that the transmission line path controller controls a propagation path length between the at least one first port to each point in the second port in a predetermined controlled manner such that a predetermined line source is formed in the second port.

19. The transmission line structure according to claim 18, characterized in that the transmission line path controller controls the propagation path length such that the propagation path length is substantially equal, independent of an electromagnetic wave propagation direction in the flared first waveguide.

20. The transmission line structure according to claim 2, characterized in that the transmission line structure comprises more than one first port.

21. The transmission line structure according to claim 2, characterized in that the at least one first port has an asymmetrical feed relationship with the first waveguide.

22. The transmission line structure according to claim 2, characterized in that the at least one first port has a symmetrical feed relationship with the first waveguide.

23. The transmission line structure according to claim 2, characterized in that the waveguides of the transmission line structure are aligned such that the first principal propagation direction, the second principal propagation direction and the controller principal propagation direction, form a plane which is perpendicular with the plates of the waveguides.

24. The transmission line structure according to claim 2, characterized in that the first waveguide and the second waveguide are aligned in relation to each other such that a projection of the first principal propagation direction and a projection of the second principal propagation direction onto the slot plane along the plane's normal, form an angle with each other separate from zero on the plane.

25. The transmission line structure according to claim 2, characterized in that the first part of the path controller is also coupled to the second end of the second waveguide and in that the controller principal propagation direction is the same as the second principal propagation direction.

26. The transmission line structure according to claim 25, characterized in that the first curved side of the first part of the path controller extends into the second waveguide and forms at least in part an end opposite the second port end of the second waveguide.

27. The transmission line structure according to claim 25, characterized in that the parallel plates of the first waveguide are parallel with the parallel plates of the second waveguide.

28. The transmission line structure according to claim 25, characterized in that the parallel plates of the first waveguide form an angle with the parallel plates of the second waveguide which is different from zero.

29. The transmission line structure according to claim 2, characterized in that the transmission line structure comprises a third parallel-plate waveguide section and in that the transmission line path controller comprises a second part comprising a second slot in a second slot plane, and in that the first part of the path controller further being coupled to a first end of the third waveguide, a second end of the third waveguide being coupled to the second part of the path controller, and in that the second part of the path controller being coupled to the second end of the second waveguide, the controller principal propagation direction for an electromagnetic wave entering the at least one first port is in a direction from the first end of the third waveguide towards the second end of the third waveguide.

30. The transmission line structure according to claim 29, characterized in that the second slot plane is parallel to the plates of the third waveguide.

31. The transmission line structure according to claim 29, characterized in that the second slot plane is symmetrically oriented between the parallel plates of the second and third waveguides.

32. The transmission line structure according to claim 29, characterized in that the first waveguide and the third waveguide are aligned in relation to each other such that a projection of the first principal propagation direction and a projection of the controller principal propagation direction onto a plane parallel to the plates of the first parallel-plate waveguide along the plane's normal, form an angle with each other separate from zero on the plane.

33. The transmission line structure according to claim 29, characterized in that the parallel plates of the first waveguide are parallel with the parallel plates of the second waveguide.

34. The transmission line structure according to claim 33, characterized in that the parallel plates of the first waveguide form an angle with the parallel plates of the third waveguide which is different from zero.

35. The transmission line structure according to claim 33, characterized in that the parallel plates of the first waveguide are parallel with the parallel plates of the third waveguide.

36. The transmission line structure according to claim 29, characterized in that the parallel plates of the first waveguide form an angle with the parallel plates of the second waveguide which is different from zero.

37. The transmission line structure according to claim 36, characterized in that the parallel plates of the first waveguide form an angle with the parallel plates of the third waveguide which is different from zero.

38. The transmission line structure according to claim 36, characterized in that the parallel plates of the first waveguide are parallel with the parallel plates of the third waveguide.

39. The transmission line structure according to claim 36, characterized in that the parallel plates of the second waveguide are parallel with the parallel plates of the third waveguide.

40. The transmission line structure according to claim 29, characterized in that a side of the second slot furthest away from the second port, is curved in the second slot plane, forming a second curved side of the second part of the path controller.

41. The transmission line structure according to claim 40, characterized in that the at least one other curved side of the second slot is a side opposite the second curved side and is curved in a similar manner, the second slot thus forming a substantially uniformly formed waveguide slot.

42. The transmission line structure according to claim 40, characterized in that the second curved side of the second part of the path controller extends into the second waveguide and forming at least in part an end opposite the second port end of the second waveguide.

43. The transmission line structure according to claim 40, characterized in that the second curved side of the second part of the path controller is curved along a second curved line in the second slot plane, and in planes parallel to the second slot plane along the second curved line in these parallel planes to the extension of the second curved side.

44. The transmission line structure according to claim 43, characterized in that the second curved lines in the parallel planes are aligned along a straight line parallel to a normal to the second slot plane.

45. The transmission line structure according to claim 43, characterized in that the second curved lines in the parallel planes are aligned along a bent line.

46. The transmission line structure according to claim 40, characterized in that the second curved side of the second part of the path controller is curved along a second curved line in the second slot plane, and in planes at an angle to the second slot plane along further curved lines in these planes to the extension of the second curved side.

47. The transmission line structure according to claim 43, characterized in that the second curved line is parabolic.

48. The transmission line structure according to claim 40, characterized in that the first curved side and the second curved side are formed such that the path controller forms a Cassegrain structure.

49. The transmission line structure according to claim 40, characterized in that the first curved side and the second curved side are formed such that the path controller forms a Gregorian structure.

50. The transmission line structure according to claim 2, characterized in that each coupling between a path controller part and a waveguide comprises appropriate matchings.

51. The transmission line structure according to claim 2, characterized in that the transmission line structure is of an H-plane type.

52. The transmission line structure according to claim 2, characterized in that the transmission line structure is of an E-plane type.

53. An antenna, characterized in that the antenna comprises a transmission line structure according to claim 2.
